(19) United States
(12) Patent Application Publication
(10) Pub. No.: US 2025/0171308 A1
(43) Pub. Date: May 29, 2025

(54) FUNCTIONAL CONDUCTIVE MATERIAL, POSITIVE ELECTRODE COMPOSITE INCLUDING SAME, METHOD FOR MANUFACTURING SAME, AND LITHIUM SECONDARY BATTERY INCLUDING SAME

(71) Applicant: Research & Business Foundation Sungkyunkwan University, Suwon-si (KR)

(72) Inventors: Jun Young MOON, Incheon (KR); Hyo Joo LEE, Suwon-si (KR); Seong Hun JEONG, Suwon-si (KR); Van Chuong HO, Suwon-si (KR)

(73) Assignee: Research & Business Foundation Sungkyunkwan University, Suwon-si (KR)

(21) Appl. No.: 18/950,392

(22) Filed: Nov. 18, 2024

(30) Foreign Application Priority Data
Nov. 29, 2023 (KR) 10-2023-0169961

(51) Int. Cl. C01B 32/16; H01M 4/02; H01M 4/36; H01M 4/62; H01M 10/0525; H01M 10/0562

(52) U.S. Cl. CPC C01B 32/16; H01M 4/625; H01M 10/0525; H01M 10/0562; C01P 2002/82; C01P 2002/90; H01M 2004/028; H01M 4/362; H01M 2300/008

(57) ABSTRACT

A method for manufacturing a functional conductive material according to the present invention includes: preparing g a conductive material; reducing the conductive material; and oxidizing the reduced conductive material, in which the conductive material is sequentially reduced and oxidized so that an oxygen functional group is formed on a surface of the conductive material.

### CROSS-REFERENCE TO RELATED APPLICATION(S)

This application is based on and claims priority under 35 U.S.C. 119 to Korean Patent Application No. 10-2023-0169961, filed on Nov. 29, 2023, in the Korean Intellectual Property Office, the disclosure of which is herein incorporated by reference in its entirety.

### BACKGROUND OF THE INVENTION

### 1. Field of the Invention

The present invention relates to a functional conductive material, a positive electrode composite including the same, a method for manufacturing the same, and a lithium secondary battery including the same, and more specifically, the present invention relates to a functional conductive material having a carbon structure and an oxygen functional group provided on a surface of the carbon structure, a positive electrode composite including the same, a method for manufacturing the same, and a lithium secondary battery including the same.

### 2. Description of the Related Art

Lithium secondary batteries have higher energy density than other types of secondary batteries, and thus are widely used in various fields such as portable electronic devices, electric vehicles, and energy storage systems. However, as the risk of fire and explosion of lithium secondary batteries has recently emerged, interest in safety issues related to the lithium secondary batteries is being increased. To solve this problem, all-solid-state batteries are being attracted attention. The all-solid-state battery is a technology capable of providing higher safety compared to the lithium secondary battery. The risk of fire and explosion of the lithium secondary battery occurs mainly because it contains liquid lithium ions, which are electrolytes, and all-solid-state batteries solve this problem by using solid or ceramic electrolytes instead of liquids.

The all-solid-state battery is considered safer because it has excellent stability and fire response capability of solid electrolytes. In addition, the lithium secondary battery may have a longer lifespan and higher energy density compared to the lithium secondary battery, and thus is expected to be promisingly applied in fields requiring high performance, such as portable electronic devices and electric vehicles.

Accordingly, various materials related to all-solid-state batteries are being researched and developed.

For example, Korean Registered Patent No. 10-2602094 discloses an electrode composite sheet for an all-solid-state battery including a metal foil current collector and an electrode composite formed in multiple layers by multi-coating a slurry on the metal foil current collector, in which the slurry includes an active material, a sulfide-based solid electrolyte, a conductive material, and a binder, the electrode composite includes a plurality of unit electrode composites stacked on the metal foil current collector, and the plurality of unit electrode composites have a lower ratio of the sulfide-based solid electrolyte included in the unit electrode composite as the unit electrode composites go upward from the metal foil current collector, and have a smaller thickness as the unit electrode composites go upward from the metal foil current collector.

### SUMMARY OF THE INVENTION

One technical problem to be solved by the present invention is to provide a method for manufacturing a functional conductive material having an oxygen functional group provided on a surface thereof.

Another technical problem to be solved by the present invention is to provide a method for manufacturing a positive electrode composite with improved charge/discharge capacity, Coulombic efficiency, and rate characteristics.

Still another technical problem to be solved by the present invention is to provide a lithium secondary battery with improved charge/discharge capacity, Coulombic efficiency, and rate characteristics.

Still another technical problem to be solved by the present invention is to provide a method for manufacturing a functional conductive material with a reduced manufacturing process cost.

Still another technical problem to be solved by the present invention is to provide a method for manufacturing a functional conductive material with a reduced manufacturing time.

Still another technical problem to be solved by the present invention is to provide a method for manufacturing a functional conductive material that is easy for mass-production.

The technical problems to be solved by the present invention are not limited to those described above.

To solve the above technical problems, the present invention provides a method for manufacturing a functional conductive material.

According to one embodiment, the method for manufacturing a functional conductive material may include: preparing a conductive material; reducing the conductive material; and oxidizing the reduced conductive material, in which the conductive material may be sequentially reduced and oxidized so that an oxygen functional group is formed on a surface of the conductive material.

According to one embodiment, in the reducing of the conductive material, the conductive material may be heat-treated in an inert gas atmosphere.

According to one embodiment, at least any one of a carbonyl functional group, a sulfate functional group, a nitrate functional group, or an aldehyde functional group may be removed from the surface of the conductive material by the reduction.

According to one embodiment, a ratio (D/G) of a D peak (1, 350 cm⁻¹), which corresponds to double resonance generated due to a disordered crystal structure of the conductive material, to a G peak (1,582 cm⁻¹), which corresponds to planar vibration between carbon atoms in an aligned graphene sheet, may be increased by the reduction, and the D peak and the G peak may be observed in Raman analysis of the reduced conductive material.

According to one embodiment, a reduction heat treatment temperature of the conductive material may be 200° C. to 1, 200° C., and a reduction heat treatment time of the conductive material may be 1 hour to 8 hours.

According to one embodiment, in the oxidizing of the reduced conductive material, the reduced conductive material may be heat-treated in an air atmosphere.

According to one embodiment, a ratio (D/G) of a D peak (1, 350 cm⁻¹), which corresponds to double resonance generated due to a disordered crystal structure of the conductive material, to a G peak (1,582 cm⁻¹), which corresponds to planar vibration between carbon atoms in an aligned graphene sheet, may be increased by the oxidation, as compared to the reduced conductive material, and the D peak and the G peak may be sequentially observed in Raman analysis of the reduced and oxidized conductive material.

According to one embodiment, an oxidation heat treatment temperature of the reduced conductive material may be 25° C. to 500° C., and an oxidation heat treatment time of the reduced conductive material may be 30 minutes to 5 hours.

To solve the above technical problems, the present invention provides a method for manufacturing a positive electrode composite using the above-described functional conductive material.

According to one embodiment, the method for manufacturing a positive electrode composite may include: preparing the above-described functional conductive material and a positive electrode active material; and physically mixing the functional conductive material and the positive electrode active material to manufacture the positive electrode composite.

According to one embodiment, in the physically mixing of the functional conductive material and the positive electrode active material to manufacture the positive electrode composite, an electrolyte may be further provided before physically mixing the functional conductive material and the positive electrode active material, the electrolyte may include a solid electrolyte, and the solid electrolyte may include a sulfide.

To solve the above technical problems, the present invention provides a positive electrode composite manufactured by the above-described manufacturing method.

According to one embodiment, the positive electrode composite may include: a positive electrode active material; and a functional conductive material provided on a surface of the positive electrode active material, in which the functional conductive material may include a carbon structure and an oxygen functional group provided on a surface of the carbon structure.

According to one embodiment, a ratio (D/G) of a D peak (1,350 cm−1), which corresponds to double resonance generated due to a disordered crystal structure of the functional conductive material, to a G peak (1,582 cm−1), which corresponds to planar vibration between carbon atoms in an aligned graphene sheet, may be equal to or greater than 0.323 in Raman analysis on the functional conductive material.

According to one embodiment, the functional conductive material may have oxygen atoms in a proportion of 0.74% or greater in XPS analysis on the functional conductive material.

According to one embodiment, the positive electrode composite may further include an electrolyte provided on the surface of the positive electrode active material to surround the positive electrode active material and the functional conductive material, in which the electrolyte may include a sulfide-based solid electrolyte.

To solve the above technical problems, the present invention provides a lithium secondary battery in which the above-described positive electrode composite is applied to a positive electrode.

According to one embodiment, the lithium secondary battery may include: a positive electrode including the above-described positive electrode composite; a negative electrode disposed while being spaced apart from the positive electrode; and an electrolyte disposed between the positive electrode and the negative electrode, in which a side reaction between the positive electrode and the electrolyte may be decreased by the functional conductive material in which the oxygen functional group is provided on the surface of the positive electrode composite of the positive electrode, thereby improving charge/discharge capacity and rate characteristics.

The method for manufacturing a functional conductive material according to the present invention may include: preparing a conductive material; reducing the conductive material; and oxidizing the reduced conductive material.

Accordingly, it is possible to manufacture the functional conductive material having an oxygen functional group provided on a surface of the conductive material by sequentially reducing and oxidizing the conductive material.

In addition, the method for manufacturing a positive electrode composite including the functional conductive material may include: preparing the functional conductive material, a positive electrode active material, and an electrolyte; and physically mixing the functional conductive material, the positive electrode active material, and the electrolyte to manufacture the positive electrode composite.

The positive electrode active material may include Ni. Therefore, in the physically mixing of the functional conductive material, the positive electrode active material, and the electrolyte to manufacture the positive electrode composite, it is possible to control an oxidation degree of the functional conductive material according to a content of Ni in the positive electrode active material. Accordingly, it is possible to manufacture the positive electrode composite with an increased oxidation degree of the functional conductive material by using the positive electrode active material including a high content of Ni.

Accordingly, the positive electrode composite manufactured by the above-described method for manufacturing a positive electrode composite may include: the positive electrode active material, the functional conductive material provided on the surface of the positive electrode active material; and the electrolyte provided on the surface of the positive electrode active material and surrounding the positive electrode active material and the functional conductive material. Accordingly, when the positive electrode composite is applied to a positive electrode of the lithium secondary battery, it is possible to provide the lithium secondary battery with improved charge/discharge capacity, Coulombic efficiency, and rate characteristics by the oxygen functional group provided on the surface of the functional conductive material.

### BRIEF DESCRIPTION OF THE DRAWINGS

FIG. 1 is a flowchart for explaining a method for manufacturing a functional conductive material according to an embodiment of the present invention.

FIG. 2 is a view for explaining a conductive material according to the embodiment of the present invention.

FIG. 3 is a view for explaining a method for reducing the conductive material according to the embodiment of the present invention.

FIG. 4 is a view for explaining a method for oxidizing the reduced conductive material according to the embodiment of the present invention.

FIG. 5 is a flowchart for explaining a method for manufacturing a positive electrode composite according to the embodiment of the present invention.

FIG. 6 is a view for explaining the functional conductive material, a positive electrode active material, and an electrolyte according to the embodiment of the present invention.

FIG. 7 is a view for explaining a method for manufacturing the positive electrode composite by mixing the functional conductive material, the positive electrode active material, and the electrolyte according to the embodiment of the present invention.

FIG. 8 is a view for explaining the positive electrode composite according to the embodiment of the present invention.

FIG. 9 is a view for explaining a lithium secondary battery in which the positive electrode composite is applied to a positive electrode according to the embodiment of the present invention.

FIGS. 10 and 11 are graphs for comparing chemical properties of the conductive material according to Experimental Example 1, Comparative Example 1, and Comparative Example 2 of the present invention.

FIGS. 12 to 14 are graphs for comparing electrochemical properties of the lithium secondary battery according to Experimental Example 1, Comparative Example 1, Comparative Example 2, and Comparative Example 3 of the present invention.

FIG. 15 is a graph for comparing side reactions of the lithium secondary battery according to Experimental Example 2, Comparative Example 4, Comparative Example 5, and Comparative Example 6 of the present invention.

FIG. 16 is a table for comparing electrochemical properties of the lithium secondary battery according to Experimental Example 3, Comparative Example 1-1 and Comparative Example 2-1 of the present invention.

FIG. 17 is a table for comparing electrochemical properties of the lithium secondary battery according to Experimental Example 1, Experimental Example 1-1, and Experimental Example 1-2 of the present invention.

FIG. 18 is a table for comparing electrochemical properties of the lithium secondary battery according to Experimental Examples 1-3 to 1-5 of the present invention.

### DETAILED DESCRIPTION OF THE INVENTION

Hereinafter, preferred embodiments of the present invention will be described in detail with reference to the accompanying drawings. However, the present invention may be embodied in different forms and should not be construed as limited to the embodiments set forth herein. Rather, the embodiments are provided so that this disclosure will be thorough and complete, and will fully convey the scope of the present invention to those skilled in the art.

In the present specification, it will be understood that when an element is referred to as being “on” another element, it can be formed directly on the other element or intervening elements may be present. In the drawings, the thicknesses of layers and regions are exaggerated for clarity.

In addition, it will be also understood that although the terms first, second, third, etc. may be used herein to describe various elements, these elements should not be limited by these terms. These terms are only used to distinguish one element from another element. Thus, a first element in some embodiments may be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combinations thereof, and they should not exclude the possibilities of combination or addition of one or more features, numbers, operations, elements, or a combination thereof. Furthermore, it will be understood that when an element is referred to as being “connected” or “coupled” to another element, it may be directly connected or coupled to the other element or intervening elements may be present.

In addition, when detailed descriptions of related known functions or constitutions are considered to unnecessarily cloud the gist of the present invention in describing the present invention below, the detailed descriptions will not be included.

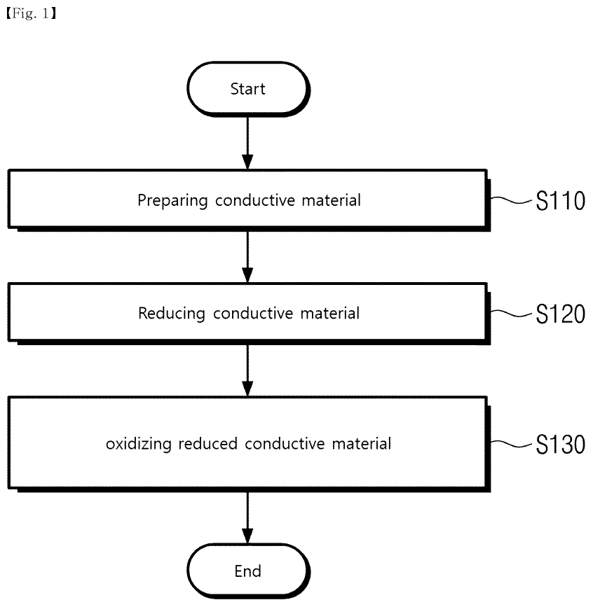

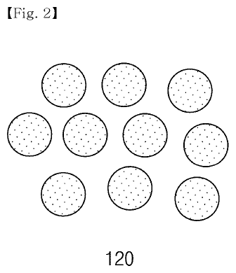

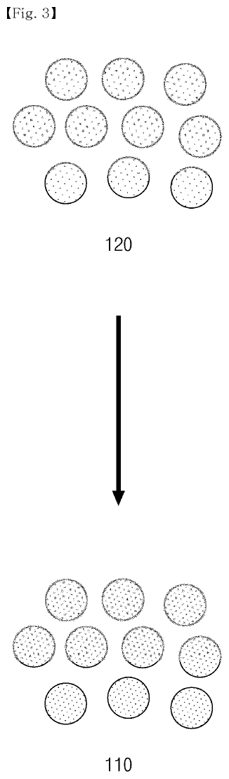

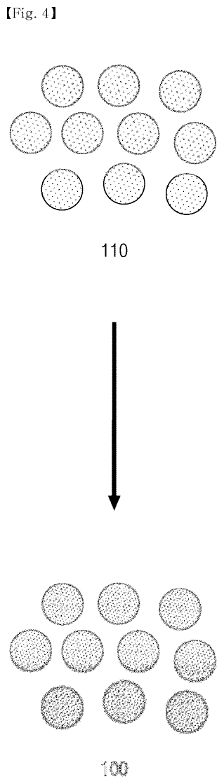

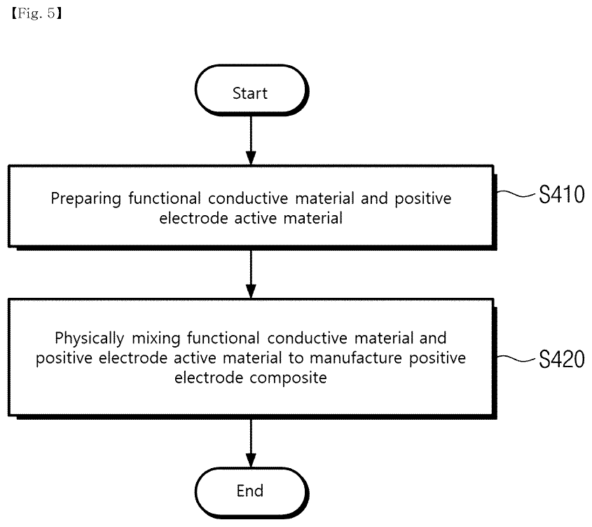

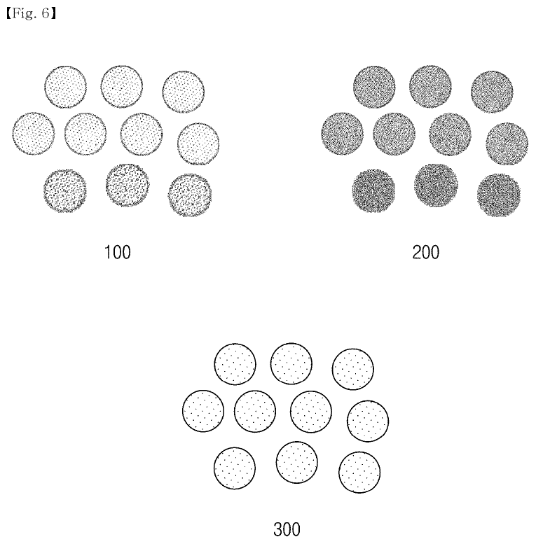

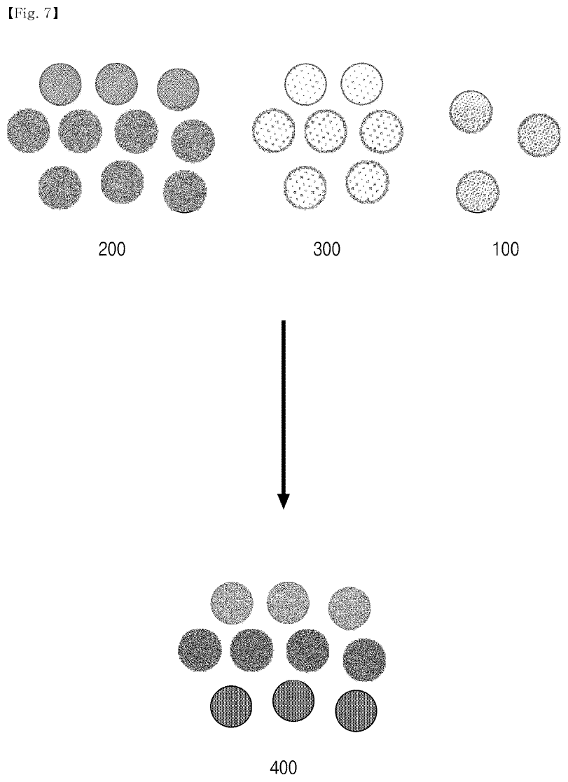

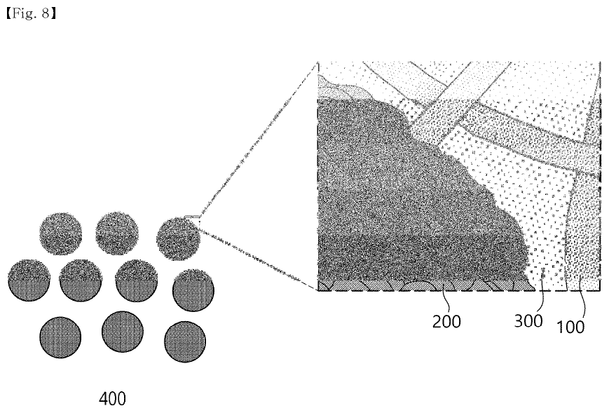

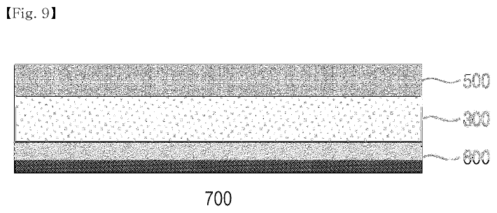

FIG. 1 is a flowchart for explaining a method for manufacturing a functional conductive material according to an embodiment of the present invention, FIG. 2 is a view for explaining a conductive material according to the embodiment of the present invention, FIG. 3 is a view for explaining a method for reducing the conductive material according to the embodiment of the present invention, FIG. 4 is a view for explaining a method for oxidizing the reduced conductive material according to the embodiment of the present invention, FIG. 5 is a flowchart for explaining a method for manufacturing a positive electrode composite according to the embodiment of the present invention, FIG. 6 is a view for explaining the functional conductive material, a positive electrode active material, and an electrolyte according to the embodiment of the present invention, FIG. 7 is a view for explaining a method for manufacturing the positive electrode composite by mixing the functional conductive material, the positive electrode active material, and the electrolyte according to the embodiment of the present invention, FIG. 8 is a view for explaining the positive electrode composite according to the embodiment of the present invention, and FIG. 9 is a view for explaining a lithium secondary battery in which the positive electrode composite is applied to a positive electrode according to the embodiment of the present invention.

Referring to FIGS. 1 and 2, a conductive material 120 is prepared (S110).

The conductive material 120 may include a carbon structure. For example, the conductive material 120 may include a multi-walled carbon nanotube (MWCNT).

Referring to FIGS. 1 to 3, the conductive material 120 is reduced (S120).

The conductive material 120 may be heat-treated in an inert atmosphere by the reduction of the conductive material 120. For example, the inert atmosphere may be a mixed gas atmosphere in which hydrogen gas and argon gas are mixed. For example, a reduction heat treatment temperature of the conductive material 120 may be 200° C. to 1,200° C. In addition, a reduction heat treatment time of the conductive material 120 may be 1 hour to 8 hours. Accordingly, the conductive material 120 may be easily reduced to form a reduced conductive material 110. Therefore, an amount of carbon in the reduced conductive material 110 may be increased, and unnecessary functional groups may be removed. For example, the unnecessary functional groups may be carbonyl, sulfate, nitrate, and aldehyde.

In addition, a ratio (D/G) of a D peak (1,350 cm⁻¹), which corresponds to double resonance generated due to a disordered crystal structure of the reduced conductive material 110, to a G peak (1,582 cm⁻¹), which corresponds to planar vibration between carbon atoms in an aligned graphene sheet, may be increased in Raman analysis on the reduced conductive material 110. For example, the D/G of the conductive material 120 may be 0.173. For example, the D/G of the reduced conductive material 110 may be 0.222.

Referring to FIGS. 1 and 4, the reduced conductive material 110 is oxidized (S130).

The reduced conductive material 110 may be heat-treated in an air atmosphere by the oxidation of the conductive material 110. For example, the air atmosphere may be an oxygen atmosphere. For example, an oxidation heat treatment temperature of the reduced conductive material 110 may be 25° C. to 500° C. In addition, an oxidation heat treatment time of the reduced conductive material 110 may be 30 minutes to 5 hours. Accordingly, the reduced conductive material 110 may be easily oxidized to form a functional conductive material 100. Therefore, an oxygen functional group may be formed on a surface of the functional conductive material 100. That is, the functional conductive material 100 may be manufactured by sequentially reducing and oxidizing the conductive material 120, and thus the oxygen functional group may be provided on the surface of the functional conductive material 100. In other words, an oxidation degree of the functional conductive material 100, which is manufactured by sequentially reducing and oxidizing the conductive material 120, may be increased.

In addition, the ratio (D/G) of the D peak (1, 350 cm⁻¹), which corresponds to double resonance generated due to a disordered crystal structure of the functional conductive material 100, to the G peak (1, 582 cm⁻¹), which corresponds to planar vibration between carbon atoms in an aligned graphene sheet, may be increased in Raman analysis on the functional conductive material 100. For example, the D/G of the conductive material 120 may be 0.173. For example, the D/G of the reduced conductive material 110 may be 0.222. For example, the D/G of the functional conductive material 100 may be 0.323.

Accordingly, charge/discharge capacity, Coulombic efficiency, and rate characteristics of a lithium secondary battery to be described below may be improved by the oxygen functional group provided on the surface of the functional conductive material 100.

As a result, the method for manufacturing the functional conductive material 100 according to the embodiment of the present application may include a step of preparing the conductive material 120, a step of reducing the conductive material 120, and a step of oxidizing the reduced conductive material 110.

Accordingly, it is possible to manufacture the functional conductive material 100 having the oxygen functional group provided on the surface of the conductive material by sequentially reducing and oxidizing the conductive material 120. Therefore, a lithium secondary battery with improved charge/discharge capacity, Coulombic efficiency, and rate characteristics may be provided.

Referring to FIGS. 5 and 6, the functional conductive material 100 and a positive electrode active material 200 may be prepared (S410).

The functional conductive material 100 may include the carbon structure and the oxygen functional group provided on a surface of the carbon structure.

The positive electrode active material may include, for example, Ni, Mn, and Co. In addition, as a content Ni in the positive electrode active material increases, the oxidation degree of the functional conductive material 100 in a positive electrode composite 400 to be described below may increase. Accordingly, the charge/discharge capacity, the Coulombic efficiency, and the rate characteristics of the lithium secondary battery may be improved.

Referring to FIGS. 5 and 7, the functional conductive material 100 and the positive electrode active material 200 are physically mixed to manufacture the positive electrode composite 400 (S420).

In the step of physically mixing the functional conductive material 100 and the positive electrode active material 200 to manufacture the positive electrode composite 400, an electrolyte 300 may be further provided before physically mixing the functional conductive material 100 and the positive electrode active material 200.

The electrolyte 300 may include a solid electrolyte or a liquid electrolyte. For example, when the electrolyte 300 is the solid electrolyte, the solid electrolyte may include Li₆PS₅Cl.

Accordingly, the functional conductive material 100, the positive electrode active material 200, and the electrolyte 300 may be physically mixed to manufacture the positive electrode composite 400.

As a result, the method for manufacturing the positive electrode composite 400 according to the embodiment of the present application may include a step of preparing the functional conductive material 100, the positive electrode active material 200, and the electrolyte 300, and a step of physically mixing the functional conductive material 100, the positive electrode active material 200, and the electrode electrolyte 300 to manufacture the positive composite 400.

The positive electrode active material 200 may include Ni. Therefore, in the step of physically mixing the functional conductive material 100, the positive electrode active material 200, and the electrolyte 300 to manufacture the positive electrode composite 400, it is possible to control the oxidation degree of the functional conductive material 100 according to the content of Ni in the positive electrode active material 200. Accordingly, it is possible to manufacture the positive electrode composite 400 with the increased oxidation degree of the functional conductive material 100 by using the positive electrode active material 200 including a high content of Ni. Therefore, the lithium secondary battery with improved charge/discharge capacity, Coulombic efficiency, and rate characteristics may be provided.

Referring to FIG. 3, the positive electrode composite 400 will be described.

The positive electrode composite 400 may further include the electrolyte 300 provided on the positive electrode active material 200, the functional conductive material provided on the surface of the positive electrode active material 200, and the surface of the positive electrode active material 200 and surrounding the positive electrode active material 200 and the functional conductive material 100.

The functional conductive material 100 may include the carbon structure and the oxygen functional group provided on the surface of the carbon structure. For example, the carbon structure may be the MWCNT. In addition, the electrolyte 300 may be the solid d electrolyte. For example, when the electrolyte 300 may include Li₆PS₅Cl.

In addition, the ratio (D/G) of the D peak (1, 350 cm⁻¹), which corresponds to double resonance generated due to a disordered crystal structure of the functional conductive material 100, to the G peak (1,582 cm⁻¹), which corresponds to planar vibration between carbon atoms in an aligned graphene sheet, may be equal to or greater than 0.323 in Raman analysis on the functional conductive material 100 of the positive electrode composite 400.

In addition, the functional conductive material 100 may have oxygen atoms in a proportion of 0.74% in XPS analysis on the functional conductive material 100 of the positive electrode composite 400.

Therefore, the lithium secondary battery with improved charge/discharge capacity, Coulombic efficiency, and rate characteristics may be provided by the oxygen functional group provided on the surface of the functional conductive material 100 of the positive electrode composite 400.

Referring to FIG. 9, a lithium secondary battery 700 in which the positive electrode composite 400 is applied to a positive electrode 500 will be described.

The lithium secondary battery 700 may include the positive electrode 500 including the positive electrode composite 400, a negative electrode 600 disposed while being spaced apart from the positive electrode 500; and the electrolyte 300 disposed between the positive electrode 500 and the negative electrode 600. For example, the negative electrode may include a lithium-indium alloy. For example, the electrolyte 300 may include a solid electrolyte or a liquid electrolyte. For example, when the electrolyte 300 is the solid electrolyte, the electrolyte 300 may include Li₆PS₅Cl.

A side reaction between the positive electrode 500 and the electrolyte 300 may be decreased by the functional conductive material 100 having the oxygen functional group provided in the positive electrode composite 400 of the positive electrode 500 of the lithium secondary battery 700. Therefore, the lithium secondary battery 700 with improved charge/discharge capacity, Coulombic efficiency, and rate characteristics may be provided.

Hereinafter, specific experimental examples and characteristic evaluation results of the conductive material, the positive electrode composite, and the lithium secondary battery according to the embodiment of the present invention will be described.

### Conductive Material According to Experimental Example 1

As the conductive material, a multi-walled carbon nanotube (MWCNT, diameter: 20 nm to 30 nm, length: 5 um to 15 um) was prepared. The conductive material was heated to 900° C. (temperature increase rate: 5° C./min) in an inert atmosphere (hydrogen gas (5 wt %)+argon gas, hydrogen gas flow rate: 100 sccm), and reduced for 6 hours. The reduced conductive material was heated to 300° C. (temperature increase rate: 5° C./min) in an air atmosphere (air flow rate: 100 sccm), and oxidized for 2 hours to manufacture a functional conductive material (O-MWCNT) having an oxygen functional group provided on a surface thereof.

### Conductive Material According to Experimental Example 1-1

A conductive material (O-MWCNT-0.5 hr) according to Experimental Example 1-1 was manufactured in the same manner as the method for manufacturing the conductive material according to Experimental Example 1, except that the reduced conductive material was heated to 300° C. (temperature increase rate: 5° C./min) in an air atmosphere (air flow rate: 100 sccm), and oxidized for 30 minutes.

### Conductive Material According to Experimental Example 1-2

A conductive material (O-MWCNT-4 hr) according to Experimental Example 1-2 was manufactured in the same manner as the method for manufacturing the conductive material according to Experimental Example 1, except that the reduced conductive material was heated to 300° C. (temperature increase rate: 5° C./min) in an air atmosphere (air flow rate: 100 sccm), and oxidized for 4 minutes.

### Conductive Material According to Comparative Example 1

As the conductive material, a multi-walled carbon nanotube (MWCNT, diameter: 20 nm to 30 nm, length: 5 um to 15 um) was prepared. The conductive material was heated to 900° C. (temperature increase rate: 5° C./min) in an inert atmosphere (hydrogen gas (5 wt %)+argon gas, hydrogen gas flow rate: 100 sccm), and reduced for 6 hours to manufacture a conductive material (R-MWCNT, Reduced-MWCNT) according to Comparative Example 1.

### Conductive Material According to Comparative Example 2

As the conductive material according to Comparative Example 2, a multi-walled carbon nanotube (MWCNT, diameter: 20 nm to 30 nm, length: 5 um to 15 um) was prepared.

### Conductive Material According to Comparative Example 3

As the conductive material according to Comparative Example 3, SUPER-C was prepared.

TABLE 1

| Classification | Conductive material | Note |
|---|---|---|
| Experimental | O-MWCNT | Reduction (6 h) → |
| Example 1 | | Oxidation (2 h) |
| Experimental | O-MWCNT | Reduction (6 h) → |
| Example 1-1 | | Oxidation (0.5 h) |
| Experimental | O-MWCNT | Reduction (6 h) → |
| Example 1-2 | | Oxidation (4 h) |
| Comparative | R-MWCNT | Reduction (6 h) |
| Example 1 | | |
| Comparative | MWCNT | — |
| Example 2 | | |
| Comparative | SUPER-C | — |
| Example 3 | | |

### Positive Electrode Composite According to Experimental Example 1

A conductive material (O-MWCNT) according to Experimental Example 1, a positive electrode active material (NCM powder (N86)), diameter: about 9 um), and a solid electrolyte (Li6PS5Cl powder, diameter: about 1 um) were prepared.

The positive electrode active material, the solid electrolyte, and the conductive material were provided to a Voltex Mixer so as to have a weight ratio of 85:14:1 and mixed the same to manufacture a positive electrode composite.

### Positive Electrode Composite According to Experimental Example 1-1

A positive electrode composite according to Experimental Example 1-1 was manufactured in the same manner as the method for manufacturing the positive electrode composite according to Experimental Example 1, except that the positive electrode active material, the solid electrolyte, and the conductive material were provided to a Voltex Mixer so as to have a weight ratio of 70:29:1.

### Positive Electrode Composite According to Experimental Example 1-2

A positive electrode composite according to Experimental Example 1-2 was manufactured in the same manner as the method for manufacturing the positive electrode composite according to Experimental Example 1, except that the positive electrode active material, the solid electrolyte, and the conductive material were provided to a Voltex Mixer so as to have a weight ratio of 70:28:2.

### Positive Electrode Composite According to Experimental Example 1-3

A positive electrode composite according to Experimental Example 1-3 was manufactured in the same manner as the method for manufacturing the positive electrode composite according to Experimental Example 1, except that the conductive material according to Experimental Example 1-2 was prepared as the conductive material and Li_{5.5}PS_{4.5}ClBr_{0.5} was prepared as the solid electrolyte.

### Positive Electrode Composite According to Experimental Example 1-4

A positive electrode composite according to Experimental Example 1-4 was manufactured in the same manner as the method for manufacturing the positive electrode composite according to Experimental Example 1, except that the conductive material according to Experimental Example 1-3 was prepared as the conductive material and Li_{5.5}PS_{4.5}ClBr_{0.5} was prepared as the solid electrolyte.

### Positive Electrode Composite According to Experimental Example 1-5

A positive electrode composite according to Experimental Example 1-5 was manufactured in the same manner as the method for manufacturing the positive electrode composite according to Experimental Example 1, except that Li_{5.5}PS_{4.5}ClBr_{0.5} was prepared as the solid electrolyte.

### Positive Electrode Composite According to Experimental Example 2

The conductive material (O-MWCNT) according to Experimental Example 1 and the solid electrolyte (Li₆PS₅Cl powder, diameter: about 1 um) were prepared.

The solid electrolyte and the conductive material were provided to a Voltex Mixer so as to have a weight ratio of 70:30 and mixed the same to manufacture a positive electrode composite.

### Positive Electrode Composite According to Experimental Example 3

A positive electrode composite was manufactured in the same manner as the method for manufacturing the positive electrode composite according to Experimental Example 1, except that NCM333 having a content of Ni that is lower than that of NCM powder (N86) was prepared as the positive electrode active material.

### Positive Electrode Composite According to Comparative Example 1

A positive electrode composite (R-MWCNT) according to Comparative Example 1 was manufactured in the same manner as the method for manufacturing the positive electrode composite according Experimental Example 1, except that the conductive material (R-MWCNT) according to Comparative Example 1 was prepared as the conductive material.

### Positive Electrode Composite According to Comparative Example 1-1

A positive electrode composite according to Comparative Example 1-1 was manufactured in the same manner as the method for manufacturing the positive electrode composite according to Experimental Example 1, except that NCM333 having a content of Ni that is lower than that of NCM powder (N86) was prepared as the positive electrode active material and the conductive material (R-MWCNT) according to Comparative Example 1 was prepared as the conductive material.

### Positive Electrode Composite According to Comparative Example 2

A positive electrode composite (MWCNT) according to Comparative Example 2 was manufactured in the same manner as the method for manufacturing the positive electrode composite according to Experimental Example 1, except the conductive material (MWCNT) according to Comparative Example 2 was prepared as the conductive material.

### Positive Electrode Composite According to Comparative Example 2-1

A positive electrode composite according to Comparative Example 2-1 was manufactured in the same manner as the method for manufacturing the positive electrode composite according to Experimental Example 1, except that NCM333 having a content of Ni that is lower than that of NCM powder (N86) was prepared as the positive electrode active material and the conductive material (MWCNT) according to Comparative Example 2 was prepared as the conductive material.

### Positive Electrode Composite According to Comparative Example 3

A positive electrode composite (Super-C) according to Comparative Example 3 was manufactured in the same manner as the method for manufacturing the positive electrode composite according to Experimental Example 1, except that the conductive material (Super-C) according to Comparative Example 3 was prepared as the conductive material.

TABLE 2

| | | | | Weight ratio (wt %) |
|---|---|---|---|---|
| | | | | of conductive |
| | | | Positive | material:solid |
| | | | electrode | electrolyte:positive |
| | Conductive | Solid | active | electrode |
| Classification | material | electrolyte | material | active material |
| Experimental | O-MWCNT | Li₆PS₅Cl | N86 | 85:14:1 |
| Example 1 | | | | |
| Experimental | O-MWCNT | Li₆PS₅Cl | N86 | 70:29:1 |
| Example 1-1 | | | | |
| Experimental | O-MWCNT | Li₆PS₅Cl | N86 | 70:28:2 |
| Example 1-2 | | | | |
| Experimental | O-MWCNT | Li_{5.5}PS_{4.5}ClBr_{0.5} | N86 | 85:14:1 |
| Example 1-3 | (0.5 h) | | | |
| Experimental | O-MWCNT | Li_{5.5}PS_{4.5}ClBr_{0.5} | N86 | 85:14:1 |
| Example 1-4 | (4 h) | | | |
| Experimental | O-MWCNT | Li_{5.5}PS_{4.5}ClBr_{0.5} | N86 | 85:14:1 |
| Example 1-5 | (2 h) | | | |
| Experimental | O-MWCNT | Li₆PS₅Cl | — | 70:30:0 |
| Example 2 | | | | |
| Experimental | O-MWCNT | Li₆PS₅Cl | NCM333 | 85:14:1 |
| Example 3 | | | | |
| Comparative | R-MWCNT | Li₆PS₅Cl | N86 | 85:14:1 |
| Example 1 | | | | |
| Comparative | R-MWCNT | Li₆PS₅Cl | NCM333 | 85:14:1 |
| Example 1-1 | | | | |
| Comparative | MWCNT | Li₆PS₅Cl | N86 | 85:14:1 |
| Example 2 | | | | |
| Comparative | MWCNT | Li₆PS₅Cl | NCM333 | 85:14:1 |
| Example 2-1 | | | | |
| Comparative | SUPER-C | Li₆PS₅Cl | N86 | 85:14:1 |
| Example 3 | | | | |

### Lithium Secondary Battery According to Experimental Example 1

A solid electrolyte (Li₆PS₅Cl powder, diameter: about 1 um, 100 mg) was compressed at 125 MPa to manufacture an electrolyte. The positive electrode composite (9 mg) according to Experimental Example 1 was compressed at 200 MPa on an upper surface of the electrolyte to manufacture a positive electrode. In addition, a lithium-indium alloy was disposed on a lower surface of the electrolyte to manufacture a negative electrode, thereby manufacturing a lithium secondary battery.

### Lithium Secondary Battery to Experimental Example 1-1

A lithium secondary according to Experimental Example 1-1 was manufactured in the same manner as the method for manufacturing the lithium secondary battery according to Experimental Example 1, except that the positive electrode composite according to Experimental Example 1-1 was compressed on the upper surface of the electrolyte to manufacture the positive electrode.

### Lithium Secondary Battery According to Experimental Example 1-2

A lithium secondary according to Experimental Example 1-2 was manufactured in the same manner as the method for manufacturing the lithium secondary battery according to Experimental Example 1, except that the positive electrode composite according to Experimental Example 1-2 was compressed on the upper surface of the electrolyte to manufacture the positive electrode.

### Lithium Secondary Battery According to Experimental Example 1-3

A lithium secondary according to Experimental Example 1-3 was manufactured in the same manner as the method for manufacturing the lithium secondary battery according to Experimental Example 1, except that Li_{5.5}PS_{4.5}ClBr_{0.5} serving as the solid electrolyte was compressed to manufacture the electrolyte and the positive electrode composite according to Experimental Example 1-3 was compressed on the upper surface of the electrolyte to manufacture the positive electrode.

### Lithium Secondary Battery According to Experimental Example 1-4

A lithium secondary according to Experimental Example 1-4 was manufactured in the same manner as the method for manufacturing the lithium secondary battery according to Experimental Example 1, except that Li_{5.5}PS_{4.5}ClBr_{0.5} serving as the solid electrolyte was compressed to manufacture the electrolyte and the positive electrode composite according to Experimental Example 1-4 was compressed on the upper surface of the electrolyte to manufacture the positive electrode.

### Lithium Secondary Battery According to Experimental Example 1-5

A lithium secondary according to Experimental Example 1-5 was manufactured in the same manner as the method for manufacturing the lithium secondary battery according to Experimental Example 1, except that Li_{5.5}PS_{4.5}ClBr_{0.5} serving as the solid electrolyte was compressed to manufacture the electrolyte and the positive electrode composite according to Experimental Example 1-5 was compressed on the upper surface of the electrolyte to manufacture the positive electrode.

### Lithium Secondary Battery According to Experimental Example 2

A lithium secondary was manufactured in the same manner as the method for manufacturing the lithium secondary battery according to Experimental Example 1, except that the positive electrode was manufactured on the upper surface of the electrolyte using the positive electrode composite (9 mg) according to Experimental Example 2 and the negative electrode was manufactured by disposing a lithium metal on a lower surface of the electrolyte.

### Lithium Secondary Battery According to Experimental Example 3

A lithium secondary according to Experimental Example 3 was manufactured in the same manner as the method for manufacturing the lithium secondary battery according to Experimental Example 1, except that the positive electrode was manufactured on the upper surface of the electrolyte using the positive electrode composite according to Experimental Example 3.

### Lithium Secondary Battery According to Comparative Example 1

A lithium secondary was manufactured in the same manner as the method for manufacturing the lithium secondary battery according to Experimental Example 1, except that the positive electrode was manufactured on the upper surface of the electrolyte using the positive electrode composite (9 mg) according to Comparative Example 1.

### Lithium Secondary Battery According to Comparative Example 1-1

A lithium secondary according to Comparative Example 1-1 was manufactured in the same manner as the method for manufacturing the lithium secondary battery according to Experimental Example 1, except that the positive electrode was manufactured on the upper surface of the electrolyte using the positive electrode composite (9 mg) according to Composite According to Comparative Example 1-1.

### Lithium Secondary Battery According to Comparative Example 2

A lithium secondary according to Comparative Example 2 was manufactured in the same manner as the method for manufacturing the lithium secondary battery according to Experimental Example 1, except that the positive electrode was manufactured on the upper surface of the electrolyte using the positive electrode composite according to Comparative Example 2.

### Lithium Secondary Battery According to Comparative Example 2-1

A lithium secondary according to Comparative Example 2-1 was manufactured in the same manner as the method for manufacturing the lithium secondary battery according to Experimental Example 1, except that the positive electrode was manufactured on the upper surface of the electrolyte using the positive electrode composite (9 mg) according to Composite According to Comparative Example 2-1.

### Lithium Secondary Battery According to Comparative Example

A lithium secondary according to Comparative Example 3 was manufactured in the same manner s the method for manufacturing the lithium secondary battery according to Experimental Example 1, except that the positive electrode was manufactured on the upper surface of the electrolyte using the e positive electrode composite according to Comparative Example 3.

### Lithium Secondary Battery According to Comparative Example 4

A lithium secondary was manufactured in the same manner as the method for manufacturing the lithium secondary battery according to Experimental Example 2, except that the positive electrode was manufactured on the upper surface of the electrolyte using the positive electrode composite (9 mg) according to Comparative Example 1.

### Lithium Secondary Battery According to Comparative Example 5

A lithium secondary was manufactured in the same manner as the method for manufacturing the lithium secondary battery according to Experimental Example 2, except that the positive electrode was manufactured on the upper surface of the electrolyte using the positive electrode composite (9 mg) according to Comparative Example 2.

### Lithium Secondary Battery According to Comparative Example 6

A lithium secondary was manufactured in the same manner as the method for manufacturing the lithium secondary battery according to Experimental Example 2, except that the positive electrode was manufactured on the upper surface of the electrolyte using the positive electrode composite (9 mg) according to Comparative Example 3.

TABLE 3

| | | | Positive electrode (positive | | |
|---|---|---|---|---|---|
| | | | electrode composite) | | |
| | | | Positive | | |
| | | | electrode | | |
| | Negative | | active | Solid | Conductive |
| Classification | electrode | Electrolyte | material | electrolyte | material |
| Experimental | Lithium- | Li₆PS₅Cl | N86 | Li₆PS₅Cl | O-MWCNT |
| Example 1 | indium | | (85 wt %) | (14 wt %) | (1 wt %) |
| | alloy | | | | |
| Experimental | Lithium- | Li₆PS₅Cl | N86 | Li₆PS₅Cl | O-MWCNT |
| Example 1-1 | indium | | (70 wt %) | (29 wt %) | (1 wt %) |
| | alloy | | | | |
| Experimental | Lithium- | Li₆PS₅Cl | N86 | Li₆PS₅Cl | O-MWCNT |
| Example 1-2 | indium | | (70 wt %) | (28 wt %) | (2 wt %) |
| | alloy | | | | |
| Experimental | Lithium- | Li_{5.5}PS_{4.5}ClBr_{0.5} | N86 | Li_{5.5}PS_{4.5}ClBr_{0.5} | O-MWCNT |
| Example 1-3 | indium | | | | (0.5 h) |
| | alloy | | | | |
| Experimental | Lithium- | Li_{5.5}PS_{4.5}ClBr_{0.5} | N86 | Li_{5.5}PS_{4.5}ClBr_{0.5} | O-MWCNT |
| Example 1-4 | indium | | | | (4 h) |
| | alloy | | | | |
| Experimental | Lithium- | Li_{5.5}PS_{4.5}ClBr_{0.5} | N86 | Li_{5.5}PS_{4.5}ClBr_{0.5} | O-MWCNT |
| Example 1-5 | indium | | | | (2 h) |
| | alloy | | | | |
| Experimental | Lithium | Li₆PS₅Cl | — | Li₆PS₅Cl | O-MWCNT |
| Example 2 | metal | | | | |
| Experimental | Lithium- | Li₆PS₅Cl | NCM333 | Li₆PS₅Cl | O-MWCNT |
| Example 3 | indium | | | | |
| | alloy | | | | |
| Comparative | Lithium- | Li₆PS₅Cl | N86 | Li₆PS₅Cl | R-MWCNT |
| Example 1 | indium | | | | |
| | alloy | | | | |
| Comparative | Lithium- | Li₆PS₅Cl | NCM333 | Li₆PS₅Cl | R-MWCNT |
| Example 1-1 | indium | | | | |
| | alloy | | | | |
| Comparative | Lithium- | Li₆PS₅Cl | N86 | Li₆PS₅Cl | MWCNT |
| Example 2 | indium | | | | |
| | alloy | | | | |
| Comparative | Lithium- | Li₆PS₅Cl | NCM333 | Li₆PS₅Cl | MWCNT |
| Example 2-1 | indium | | | | |
| | alloy | | | | |
| Comparative | Lithium- | Li₆PS₅Cl | N86 | Li₆PS₅Cl | SPUER-C |
| Example 3 | indium | | | | |
| | alloy | | | | |
| Comparative | Lithium | Li₆PS₅Cl | — | Li₆PS₅Cl | R-MWCNT |
| Example 4 | metal | | | | |
| Comparative | Lithium | Li₆PS₅Cl | — | Li₆PS₅Cl | MWCNT |
| Example 5 | metal | | | | |
| Comparative | Lithium | Li₆PS₅Cl | — | Li₆PS₅Cl | SPUER-C |
| Example 6 | metal | | | | |

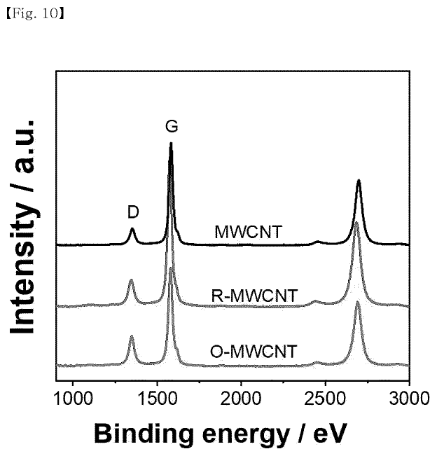

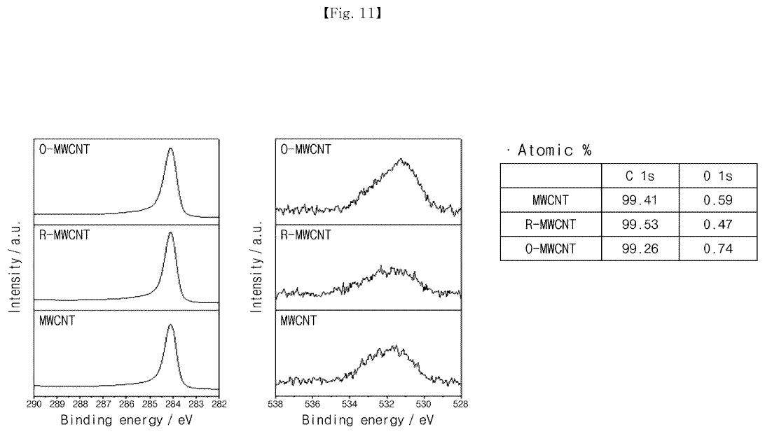

FIGS. 10 and 11 are graphs for comparing chemical properties of the conductive material according to Experimental Example 1, Comparative Example 1, and Comparative Example 2 of the present invention.

Referring to FIG. 10, Raman analysis was performed on the conductive material (O-MWCNT) according to Experimental Example 1, the conductive material (R-MWCNT) according to Comparative Example 1, and the conductive material (R-MWCNT) according to Comparative Example 2. A ratio (D/G) of a D peak (1, 350 cm⁻¹), which corresponds to double resonance generated due to a disordered crystal structure of the conductive material (O-MWCNT) according to Experimental Example 1, the conductive material (R-MWCNT) according to Comparative Example 1, and the conductive material (R-MWCNT) according to Comparative Example 2, to a G peak (1, 582 cm⁻¹), which corresponds to planar vibration between carbon atoms in an aligned graphene sheet, may be calculated. Referring to FIG. 11, proportions (%) of oxygen atoms in the conductive material (O-MWCNT) according to Experimental Example 1, the conductive material (R-MWCNT) according to Comparative Example 1, and the conductive material (R-MWCNT) according to Comparative Example 2 were measured using XPS. In addition, results thereof are summarized in <Table 4> below.

As can be seen from FIG. 10, it can be seen that the D/G ratio of the conductive material according to Experimental Example 1 is the highest. The factor is interpreted as being due to the fact that the structure of the aligned graphene sheet is deformed by the oxygen functional group provided on the surface of the conductive material according to Experimental Example 1, and the ratio of the disordered structure is increased.

As can be seen from FIG. 11, it can be seen that the proportion of oxygen in the conductive material according to Experimental Example 1 is the highest. The factor is interpreted as being due to the fact that the conductive material is sequentially reduced and oxidized during manufacturing of the conductive material according to Experimental Example 1. Accordingly, it can be seen that the oxygen functional group is formed on the surface of the conductive material according to Experimental Example 1.

Therefore, it can be seen that in the method for manufacturing a functional conductive material according to the embodiment of the present invention, the method for reducing and oxidizing the conductive material is a method for forming an oxygen functional group (functional group) on the surface of the conductive material.

TABLE 4

| | Conductive | D/G | Proportion | |
|---|---|---|---|---|
| Classification | material | ratio | of oxygen atoms | Note |
| Experimental | O-MWCNT | 0.323 | 0.74 | Reduction → |
| Example 1 | | | | Oxidation |
| Comparative | R-MWCNT | 0.222 | 0.47 | Reduction |
| Example 1 | | | | |
| Comparative | MWCNT | 0.173 | 0.59 | — |
| Example 2 | | | | |

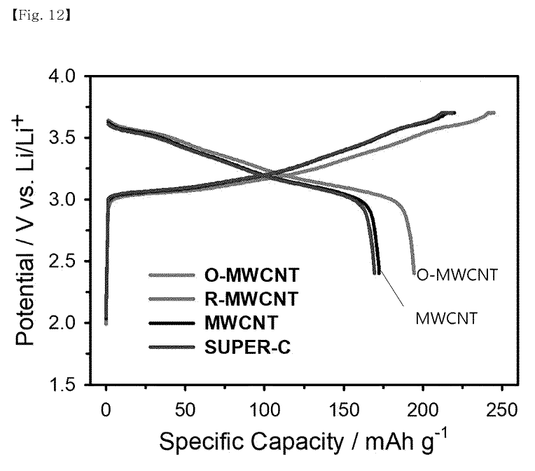

FIGS. 12 to 14 are graphs for comparing electrochemical properties of the lithium secondary battery according to Experimental Example 1, Comparative Example 1, Comparative Example 2, and Comparative Example 3 of the present invention.

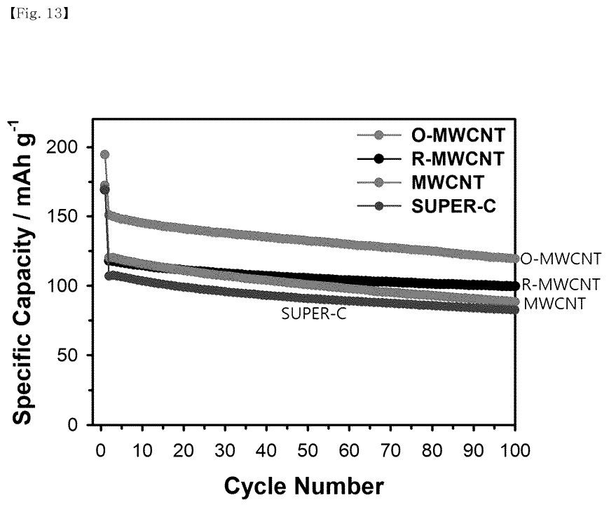

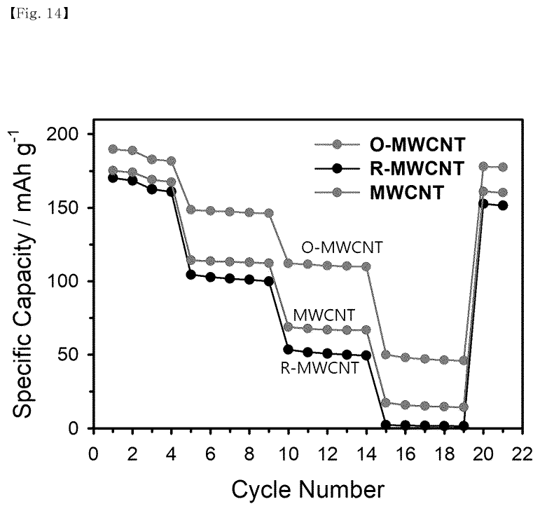

Referring to FIG. 12, charge/discharge capacities of the lithium secondary battery (O-MWCNT) according to Experimental Example 1, the lithium secondary battery (R-MWCNT) according to Comparative Example 1, the lithium secondary battery (MWCNT) according to Comparative Example 2, and the lithium secondary battery (SUPER-C) according to Comparative Example 3 were measured under the condition of 2.4 V to 3.7 V (vs. In). In addition, results thereof are summarized in <Table 5> below. Referring to FIG. 13, for the lithium secondary battery (O-MWCNT) according to Experimental Example 1, the lithium secondary battery (R-MWCNT) according to Comparative Example 1, the lithium secondary battery (MWCNT) according to Comparative Example 2, and the lithium secondary battery (SUPER-C) according to Comparative Example 3, Coulombic efficiency (C.E) and cycle retention (C.R) were measured under the conditions that one charge/discharge cycle was 0.05 C-rate and the remaining 99 charge/discharge cycles were 0.33 C-rate. In addition, results thereof are summarized in <Table 5> below. Referring to FIG. 14, rate characteristics of the lithium secondary battery (O-MWCNT) according to Experimental Example 1, the lithium secondary battery (R-MWCNT) according to Comparative Example 1, and the lithium secondary battery (MWCNT) according to Comparative Example 2 were evaluated for each charge/discharge rate (0.05 C-rate to 2 C-rate). In addition, results thereof are summarized in Table 6 below.

As can be seen from FIG. 12, it can be seen that the charge/discharge capacity of the lithium secondary battery according to Experimental Example 1 is the highest.

As can be seen from FIG. 13, it can be seen that the Coulombic efficiency and the cycle retention for the charge/discharge cycle of the lithium secondary battery according to Experimental Example 1 are the highest.

As can be seen from FIG. 14, it can be seen that the discharge capacity for each charge/discharge rate of the lithium secondary battery according to Experimental Example 1 is the highest, and the discharge cycle retention thereof is the highest. Accordingly, it can be seen that the rate characteristics of the lithium secondary battery according to Experimental Example 1 is best.

The factor is interpreted as being due to the oxygen functional group provided on the surface of the conductive material in the positive electrode of the lithium secondary battery according to Experimental Example 1. Therefore, it can be seen that the charge/discharge capacity, the Coulombic efficiency, the cycle retention, and the rate characteristics of the lithium secondary battery are improved.

TABLE 5

| | | Charge | Discharge | | |
|---|---|---|---|---|---|
| | Conductive | capacity | capacity | C.E | C.R |
| Classification | material | (mAhg⁻¹) | (mAhg⁻¹) | (%) | (%) |
| Experimental | O-MWCNT | 245.12 | 194.36 | 79.29 | 61.42 |
| Example 1 | | | | | |
| Comparative | R-MWCNT | 218.83 | 169.25 | 77.34 | 58.85 |
| Example 1 | | | | | |
| Comparative | MWCNT | 219.89 | 172.30 | 78.37 | 51.26 |
| Example 2 | | | | | |
| Comparative | SUPER-C | 218.45 | 169.40 | 77.55 | 48.65 |
| Example 3 | | | | | |

TABLE 6

| | | Specific Capacity (mAhg⁻¹) | | | | | |
|---|---|---|---|---|---|---|---|
| | Conductive | 0.05 C- | 0.1 C- | 0.5 C- | 1 C- | 2 C- | 2 C- |
| Classification | material | rate | rate | rate | rate | rate | rate |
| Experimental | O-MWCNT | 189.77 | 182.69 | 148.57 | 112.07 | 49.87 | 177.95 |
| Example 1 | | | | | | | |
| Comparative | R-MWCNT | 170.20 | 162.49 | 104.43 | 53.33 | 22.1 | 152.32 |
| Example 1 | | | | | | | |
| Comparative | MWCNT | 175.16 | 168.96 | 114.21 | 68.73 | 17.25 | 161.02 |
| Example 2 | | | | | | | |

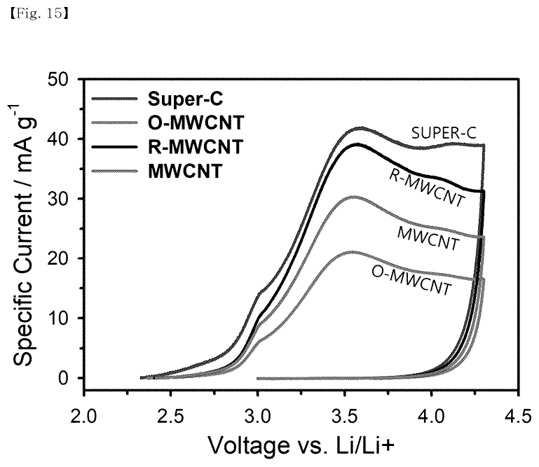

FIG. 15 is a graph for comparing side reactions of the lithium secondary battery according to Experimental Example 2, Comparative Example 4, Comparative Example 5, and Comparative Example 6 of the present invention.

Referring to FIG. 15, cyclic voltammetries (CVs) of the lithium secondary battery (O-MWCNT) according to Experimental Example 2, the lithium secondary battery (R-MWCNT) according to Comparative Example 4, the lithium secondary battery (MWCNT) according to Comparative Example 5, and the lithium secondary battery (SUPER-C) according to Comparative Example 6 were measured under the conditions of 3.0 V to 4.3 V (vs. Li/Lit) and 0.2 mV/s.

As can be seen from FIG. 15, it can be seen that the side reaction of the lithium secondary battery according to Experimental Example 2 is the smallest.

The factor is interpreted as being due to the fact that the side reaction between the positive electrode and the electrolyte is suppressed by the oxygen functional group provided on the surface of the conductive material of the positive electrode of the lithium secondary battery according to Experimental Example 2.

Therefore, it can be seen that the side reaction at an interface between the positive electrode and the electrolyte is suppressed by the oxygen functional group provided on the surface of the functional conductive material according to the embodiment of the present invention, thereby improving electrochemical properties of the lithium secondary battery.

FIG. 16 is a table for comparing electrochemical properties of the lithium secondary battery according to Experimental Example 3, Comparative Example 1-1 and Comparative Example 2-1 of the present invention.

Referring to FIG. 16, charge/discharge capacities and Coulombic efficiency of the conductive material (O-MWCNT) according to Experimental Example 3, the conductive material (R-MWCNT) according to Comparative Example 1 1, and the conductive material (MWCNT) according to Comparative Example 2-1 were measured under the condition of 2.4 V to 3.7 V (vs. In).

As can be seen from FIG. 16, it can be seen that the charge/discharge capacity and the Coulombic efficiency of the lithium secondary battery according to Experimental Example 3 are the highest. The factor is interpreted as being due to the oxygen functional group provided on the surface of the conductive material in the positive electrode of the lithium secondary battery according to Experimental Example 3.

In addition, when comparing the result described in FIG. 16 with the result described in FIG. 12, it can be seen that the oxidation degree of the conductive material is controlled according to the type of the positive electrode active material. Specifically, it can be seen that the oxidation degree of the conductive material increases as the Ni content of the positive electrode active material increases.

FIG. 17 is a table for comparing electrochemical properties of the lithium secondary battery according to Experimental Example 1, Experimental Example 1-1, and Experimental Example 1-2 of the present invention.

Referring to FIG. 17, charge/discharge capacities and Coulombic efficiency (C.E) of the conductive material (85:14:1) according to Experimental Example 1, the conductive material (70:29:1) according to Experimental Example 1 1, and the conductive material (70:28:2) according to Experimental Example 1-1 were measured under the condition of 2.4 V to 3.7 V (vs. In).

As can be seen from FIG. 17, it can be seen that the charge/discharge capacity and the Coulombic efficiency of the lithium secondary battery according to Experimental Example 1 are the highest.

Therefore, in the method for manufacturing the positive electrode composite according to the embodiment of the present application, it can be seen that the method for controlling the weight ratio of the positive electrode active material, the solid electrolyte, and the conductive material to be 85:14:1 is a method for improving the charge/discharge capacity and the Coulombic efficiency of the lithium secondary battery.

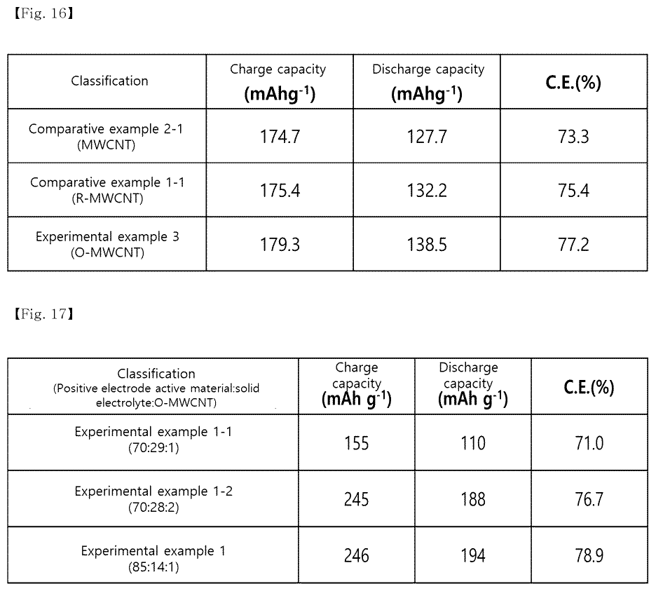

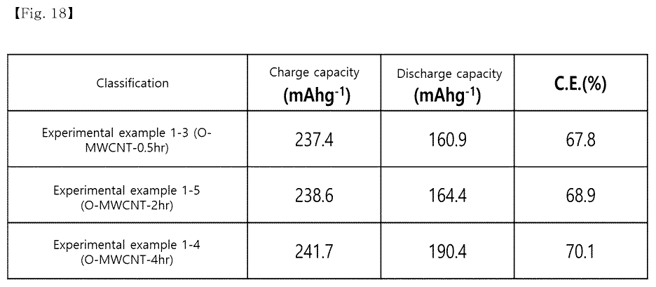

FIG. 18 is a table for comparing electrochemical properties of the lithium secondary battery according to Experimental Examples 1-3 to 1-5 of the present invention.

Referring to FIG. 18, charge/discharge capacities and Coulombic efficiency (C.E) of the conductive material (0-MWCNT-0. 5 hr-2 hr) according to Experimental Example 1-3, the conductive material (R-MWCNT) according to Comparative Example 1 1, and the conductive material (-MWCNT) according to Comparative Example 1-1 were measured under the condition of 2.4 V to 3.7 V (vs. In).

As can be seen from FIG. 18, it can be seen that the charge/discharge capacity and the Coulombic efficiency of the lithium secondary battery according to Experimental Example 1-4 are the highest.

Therefore, in the electrochemically unstable electrolyte (Li_{5.5}PS_{4.5}ClBr_{0.5}), it can be seen that a higher oxidation degree of the conductive material is required as compared with the electrochemically stable electrolyte (Li₆PS₅Cl). In addition, in the method for increasing the oxidation degree of the conductive material, it can be seen that the method for increasing the oxidation time of the reduced conductive material is a method for increasing the oxidation degree of the conductive material.

While the present invention has been described in connection with the embodiments, it is not to be limited thereto but will be defined by the appended claims. In addition, it is to be understood that those skilled in the art may substitute, change, or modify the embodiments in various forms without departing from the scope and spirit of the present invention.

What is claimed is:

1. A method for manufacturing a functional conductive material, the method comprising:
preparing a conductive material;
reducing the conductive material; and
oxidizing the reduced conductive material,
wherein the conductive material is sequentially reduced and oxidized so that an oxygen functional group is formed on a surface of the conductive material.

2. The method of claim 1, wherein in the reducing of the conductive material, the conductive material is heat-treated in an inert gas atmosphere.

3. The method of claim 2, wherein at least any one of a carbonyl functional group, a sulfate functional group, a nitrate functional group, or an aldehyde functional group is removed from the surface of the conductive material by the reduction.

4. The method of claim 3, wherein a ratio (D/G) of a D peak (1, 350 cm⁻¹), which corresponds to double resonance generated due to a disordered crystal structure of the conductive material, to a G peak (1,582 (cm⁻¹), which corresponds to planar vibration between carbon atoms in an aligned graphene sheet, is increased by the reduction, and
the D peak and the G peak are observed in Raman analysis of the reduced conductive material.

5. The method of claim 2, wherein a reduction heat treatment temperature of the conductive material is 200° C. to 1,200° C., and
a reduction heat treatment time of the conductive material is 1 hour to 8 hours.

6. The method of claim 1, wherein in the oxidizing of the reduced conductive material, the reduced conductive material is heat-treated in an air atmosphere.

7. The method of claim 6, wherein a ratio (D/G) of a D peak (1, 350 cm⁻¹), which corresponds to double resonance generated due to a disordered crystal structure of the conductive material, to a G peak (1,582 cm⁻¹), which corresponds to planar vibration between carbon atoms in an aligned graphene sheet, is increased by the oxidation, as compared to the reduced conductive material, and
the D peak and the G peak are sequentially observed in Raman analysis of the reduced and oxidized conductive material.

8. The method of claim 6, wherein an oxidation heat treatment temperature of the reduced conductive material is 25° C. to 500° C., and
an oxidation heat treatment time of the reduced conductive material is 30 minutes to 5 hours.

9. A method for manufacturing a positive electrode composite, the method comprising:
preparing the functional conductive material of claim 1 and a positive electrode active material; and
physically mixing the functional conductive material and the positive electrode active material to manufacture the positive electrode composite.

10. The method of claim 9, wherein in the physically mixing of the functional conductive material and the positive electrode active material to manufacture the positive electrode composite, an electrolyte is further provided before physically mixing the functional conductive material and the positive electrode active material,
the electrolyte includes a solid electrolyte, and
the solid electrolyte includes a sulfide.

11. A positive electrode composite comprising:
a positive electrode active material; and
a functional conductive material provided on a surface of the positive electrode active material,
wherein the functional conductive material includes a carbon structure and an oxygen functional group provided on a surface of the carbon structure.

12. The positive electrode composite of claim 11, wherein in Raman analysis on the functional conductive material, a ratio (D/G) of a D peak (1,350 cm⁻¹), which corresponds to double resonance generated due to a disordered crystal structure of the functional conductive material, to a G peak (1,582 cm⁻¹), which corresponds to planar vibration between carbon atoms in an aligned graphene sheet, is equal to or greater than 0.323.

13. The positive electrode composite of claim 11, wherein the functional conductive material has oxygen atoms in a proportion of 0.74% or greater in XPS analysis on the functional conductive material.

14. The positive electrode composite of claim 11, further comprising an electrolyte provided on the surface of the positive electrode active material to surround the positive electrode active material and the functional conductive material,
wherein the electrolyte includes a sulfide-based solid electrolyte.

15. A positive electrode composite comprising:
a positive electrode active material; and
a functional conductive material provided on a surface of the positive electrode active material,
wherein the functional conductive material includes a carbon structure and an oxygen functional group provided on a surface of the carbon structure, and
wherein a ratio (D/G) of a D peak (1,350 cm⁻¹), which corresponds to double resonance generated due to a disordered crystal structure of the functional conductive material, to a G peak (1,582 cm⁻¹), which corresponds to planar vibration between carbon atoms in an aligned graphene sheet, is equal to or greater than 0.323 in Raman analysis on the functional conductive material.

16. A lithium secondary battery comprising:
a positive electrode including the positive electrode composite of claim 11;
a negative electrode disposed while being spaced apart from the positive electrode; and
an electrolyte disposed between the positive electrode and the negative electrode,
wherein a side reaction between the positive electrode and the electrolyte is decreased by the functional conductive material in which the oxygen functional group is provided on the surface of the positive electrode composite of the positive electrode, thereby improving charge/discharge capacity and rate characteristics.
